(19) United States
(12) Patent Application Publication
(10) Pub. No.: US 2009/0073263 A1
(43) Pub. Date: Mar. 19, 2009

(54) VEHICLE PERIPHERY MONITORING SYSTEM

(75) Inventors: Taketo Harada, Obu-city (JP); Hiroaki Shimizu, Handa-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/198,471

(22) Filed: Aug. 26, 2008

(30) Foreign Application Priority Data
Sep. 18, 2007 (JP) 2007-241133

(51) Int. Cl. H04N 7/18

(52) U.S. Cl. 348/148; 348/E07.085

(57) ABSTRACT

A vehicle periphery monitoring system takes a view image of a vehicle rear periphery, which is in a predetermined area from the vehicle. This view image is converted into a bird's-eye view image and the bird's-eye view image is displayed in a vehicle compartment to assist rearward movement of a vehicle. As the vehicle approaches an obstacle, the bird's-eye view image is formed by increasing an angle of depression of the bird's-eye view image. A masking section is synthesized with the bird's-eye view image to mask a part of the bird's-eye view image not to be viewed. This masking section is increased as the depression angle increases thereby masking the distorted part of the view image.

### CROSS REFERENCE TO RELATED APPLICATION

This application is based on and incorporates herein by reference contents of Japanese Patent Application No. 2007-241133 filed on Sep. 18, 2007.

### FIELD OF THE INVENTION

The present invention relates to a vehicle periphery monitoring system, which takes a view image of vehicle periphery and displays it in a vehicle compartment so that obstacles and the like present in the vehicle periphery may be viewed by a vehicle driver in the vehicle compartment.

### BACKGROUND OF THE INVENTION

In a conventional vehicle periphery monitoring system (for instance, IP 2005-324593A), a view image of a vehicle rear periphery is taken by a camera mounted on a vehicle and a bird's-eye view image is displayed on a display in a vehicle compartment. The bird-eye view image is generated as an imaginary view by processing the original view image of the vehicle rear periphery taken by the camera.

The original view image is converted into the bird's-eye view image by, for example, conventional coordinate conversion processing, in which a road surface is used as a reference.

If the original view image includes an obstacle of a certain height, the image pixels corresponding to a part of the obstacle existing at an elevated position from the road surface are necessarily displayed at the same position as the background road surface image by the coordinate conversion processing. This background road surface is a part which is far behind from the obstacle and hidden by the part of the obstacle existing at the elevated position.

The coordinate-conversion processing thus causes distortion of the vie image of the obstacle in the bird's-eye view. That is, the obstacle view image is distorted in such a manner that it exists from the position where the obstacle actually exists to the position where the background road surface hidden behind the obstacle exists.

When the obstacle is displayed in the bird's-eye view image in such a distorted shape, it is not possible for the vehicle driver to properly recognize the size or shape of the obstacle. This bird's-eye view image will unduly oppress or puzzle the vehicle driver with the distorted obstacle image, and hence is not practically usable in assisting vehicle parking operation of the vehicle driver.

### SUMMARY OF THE INVENTION

It is therefore an object of the present invention to provide a vehicle periphery monitoring system, which controls a display mode of a bird's-eye view not to oppress or puzzle a vehicle driver even if a part of a displayed view image is distorted due to conversion of an original view image to a bird's-eye view image.

According to one aspect of the present invention, a vehicle periphery monitoring system takes an original view image of a vehicle periphery, which is in a predetermined area from the vehicle, converts at least a part of the original view image to an imaginary bird's-eye view image, and displays the bird's-eye view image in a vehicle compartment. A masking section is synthesized on the bird's-eye view image to mask a part of the bird's-eye view image not to be viewed by a vehicle driver. The masking section is variable respect to its area of masking.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a vehicle periphery monitoring system according to an embodiment of the present invention;

FIGS. 2A to 2E are bird's-eye view images displayed on a display in a vehicle compartment in the embodiment;

FIGS. 3A and 3B are graphs showing relations of a depression angle and a masking ratio relative to a distance to an obstacle in the embodiment, respectively; and

FIG. 4 is a flowchart showing display control processing executed by an ECU in the embodiment.

### DETAILED DESCRIPTION OF THE PREFERRED EMBODIMENT

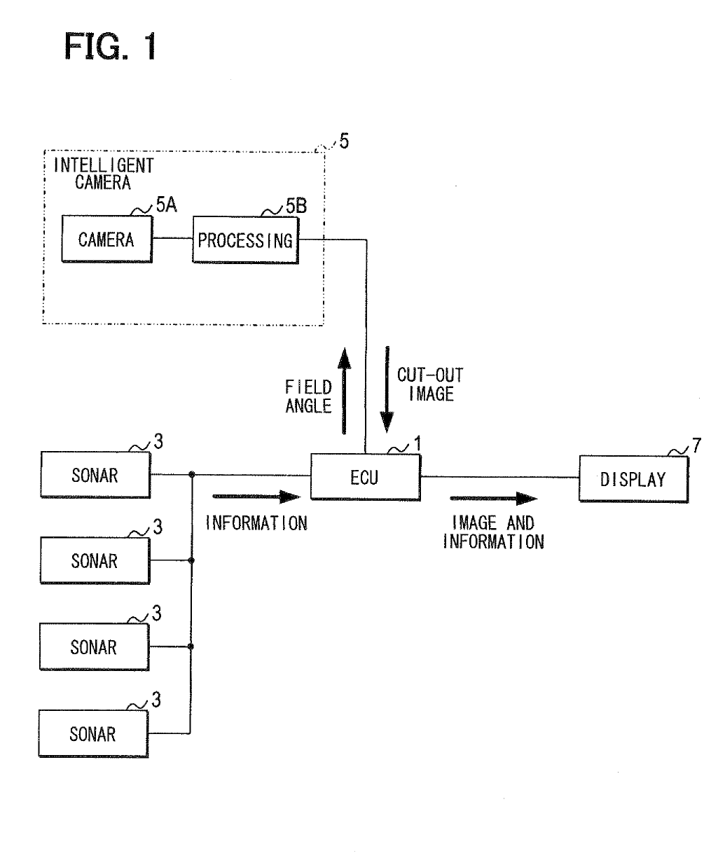

Referring first to FIG. 1, a vehicle periphery monitoring system includes an ECU 1, ultrasonic sonars 3, an intelligent camera device 5, a display 7 and the like.

The ECU 1 is an electronic control unit, which includes a microcomputer and its peripheral devices as known well and controls various parts of the vehicle periphery monitoring system. This ECU 1 may be provided exclusively to the vehicle periphery monitoring system or in common to be shared by other control systems in a vehicle.

The ECU 1 may be configured by a single unit or a plurality of units, which cooperate each other. For instance, a camera ECU for controlling a camera function may be provided as a main ECU, and a sonar ECU for controlling a sonar function may be provided as a dependent ECU, which operates under control of the camera ECU.

The ultrasonic sonars 3 are mounted at four locations in a rear part of the vehicle such as a rear bumper. Each ultrasonic sonar 3 transmits an ultrasonic wave in the rear direction of the vehicle and receives a reflection wave reflected by an obstacle. The ultrasonic sonar 3 thus detects presence of the obstacle and measures a distance from the vehicle to the obstacle. Such information as the presence of the obstacle and the distance to the obstacle provided by the ultrasonic sonar 3 is applied to the ECU 1.

The intelligent camera device 5 is also mounted at a rear part of the vehicle such as a top of a rear windshield to take a view image of the rear periphery of the vehicle. The intelligent camera device 5 includes a camera 5A and a signal processing unit 5B. The signal processing unit 5b is configured to be capable of cutting out or taking out a part of an original view image of the camera 5A by an angle of view (field angle) instructed by the ECU 1, while canceling the remaining part of the original view image. The signal processing unit 5b may be incorporated as a part of the ECU 1.

The ECU 1 specifically supplies the intelligent camera device 5 with such information as the measured distance between the vehicle and the obstacle as an instruction indicating the field angle to cut out the original view image. The intelligent camera device 5 varies the field angle in accordance with the measured distance between the vehicle and the obstacle.

The intelligent camera device 5 cuts out a part of the original view image by the field angle instructed by the ECU 1, so that a road surface extending rearward from the vehicle is at least included in the view image. Specifically, the intelligent camera device 5 determines a range of cut-out and a rule of coordinate-conversion in accordance with the distance to the obstacle. A part to be cut out from the original view image and a type of coordinate-conversion to be adopted are programmed to vary in correspondence to a distance to an obstacle. This program is stored in a ROM of the signal processing unit 5B.

The camera 5A is a wide-angle camera, which has a field angle of about 180 degrees. The original view image provided by the camera 5A is similar to a view image, which will be provided by using a fish-eye lens.

For this reason, the signal processing unit 5B is configured to subject the original view image to various image processing, which includes distortion correction processing and field angle cut-out processing. Thus, an imaginary bird's-eye view is generated based on the original view image and supplied to the ECU 1.

The display 7 is mounted in the vehicle to provide thereon the bird's-eye view which the intelligent camera device 5 supplied to the ECU 1, a masking section which is synthesized with the bird's-eye view image and information of characters and picture symbols which are overlapped on the masking section.

According to the embodiment, the rear view image of the vehicle is provided on the display 7 to assist a vehicle driver when the vehicle is moved backward to park in a parking lot, for instance. An angle of depression (depression angle) of a bird's-eye view image displayed in the vehicle compartment is made greater as the vehicle moves closer to an obstacle, when the ultrasonic sonar 3 detects an obstacle. The depression angle is opposite to an elevation angle and a downward angle of viewing direction relative to the horizontal line.

In addition, a part of the bird's-eye view image is masked by a masking section over a certain range of the depression angle. The masking section, that is, an area of the view image which is covered or hidden by the masking section, is made larger as the depression angle becomes larger. As a result, as the viewing direction is directed downward, the area displayed in the bird's-eye view image to be viewed by the vehicle driver is decreased.

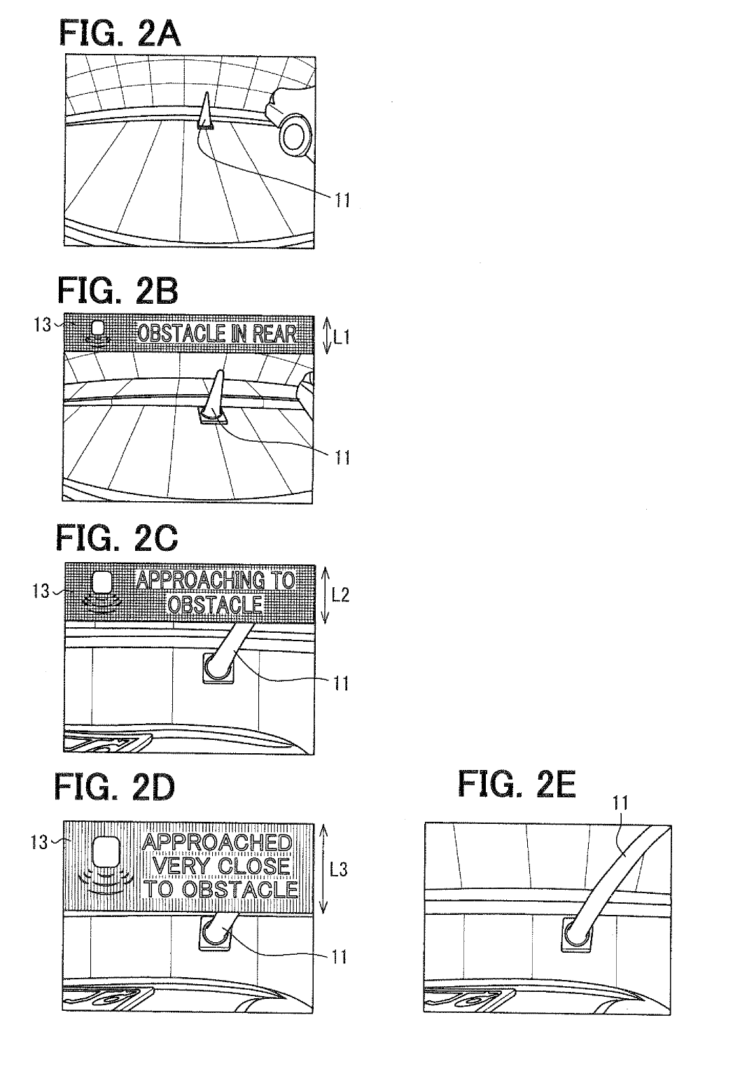

One exemplary operation of the embodiment is shown in FIGS. 2A to 2D. When the vehicle driver shifts a transmission gear to R-position (Reverse) for moving the vehicle backward, the display 7 provides a full bird's-eye view indicating a rear view including an obstacle (post) 11 having a certain height as shown in FIG. 2A. In this instance, no masking section is provided on the view image, as long as the obstacle 11 is still sufficiently away from the vehicle (more than 1.5 meters) and need not be notified in a specified manner yet to warn the vehicle driver of the obstacle.

When the vehicle starts to move backward and approaches the obstacle 11 to be less than a predetermined distance (for instance, 1.5 meters), the display 7 provides the bird's-eye view image as shown in FIG. 2B. The depression angle of this bird's-eye view image is greater than that of the view image of FIG. 2A. That is, the view image is more directed to the lower part of the rear periphery, for instance, to the foot part of the obstacle 11. Further, this view image includes a masking section 13 of a width (height) L1 (L1>0) at the top part of the view image, where the depression angle is small.

In this instance, the masking section 13 masks the top part of the view image in black. A picture symbol (sound alarm picture) and a character message are provided in the masking section 13 as warning information. The picture symbol is provided in one of three colors indicating a first stage of warning. The character message indicates “OBSTACLE IN REAR.”

When the vehicle approaches closer to the obstacle 11, the display 7 provides the bird's-eye view image as shown in FIG. 2C. The depression angle of this bird's-eye view image is greater than that of the view image of FIG. 2B. That is, the viewing direction is changed to more downward. The masking section 13 is increased to be larger to have a width (height) L2 (L2>L1).

In this instance, the masking section 13 is still in black and provides the warning information in the masking section 13 in the similar manner as in FIG. 2B. However, the warning information are provided in the larger size than in the case of FIG. 2B in correspondence to the enlargement of the masking section 13. The picture symbol is provided in another color indicating a second stage of warning, and the character message indicates “APPROACHING TO OBSTACLE.” The masking section 13 may be provided in yellow in association with a change of stage of warning.

When the vehicle approaches very close to the obstacle 11, the display 7 provides the bird's-eye view image as shown in FIG. 2D. The depression angle of this bird's-eye view image is greater than that of the view image of FIG. 2C. That is, the viewing direction is changed to more downward. The masking section 13 is made much larger and have an increased width (height) L3 (L3>L2), which occupies almost upper half area of the view image.

In this instance, the masking section 13 is changed to red color and provides the warning information in the masking section 13 in yet larger size. Specifically, the picture symbol is provided in the other color to call the driver's attention, and the character message indicates “APPROACHED VERY CLOSE TO OBSTACLE.”

Among the view images shown in FIGS. 2A to 2D, the depression angle is least in the case of FIG. 2A. Therefore, the view image covers even a remote periphery behind the vehicle so that any obstacle existing far behind may also be recognized.

The depression angle is greatest in the case of FIG. 2D. Therefore, even a rear end part including a part of a license plate of the vehicle is provided in the bottom part of the display 7, and the obstacle 11 is provided as if it is viewed down from its top side in a vertical direction. Thus, the relation between the vehicle and the obstacle 11, that is, the distance between the two, can be recognized easily.

In the view image shown in FIG. 2D, the masking section 13 masks the top part of the image in the lateral direction, where the distortion of image becomes large. As a result, the vehicle driver will not have a sense of unusualness of a distorted shape of the view image.

If no masking section is synthesized with an original bird's-eye view image, the view image provided by the display 7 will result in the image shown in FIG. 2E. In this instance, the obstacle 11 is displayed with its height and its top part being distorted very much in shape.

This distortion is caused due to a difference between an actual view point of an original view image and an imaginary view point of a bird's-eye view image. This distortion increases as an obstacle becomes higher. If such a distorted view image of the obstacle 11 is provided in the display 7, the vehicle driver will misunderstand the size (height) of the obstacle 11 and feel oppressed. It is thus preferred to eliminate the distorted view image in assisting parking operation of a vehicle.

According to the embodiment, the masking section 13 is synthesized to mask the upper part of the bird's-eye view where the distortion is large as shown in FIG. 2D, the greatly distorted area in the bird's-eye view image shown in FIG. 2E can be eliminated from being displayed by the display 7. As a result, the vehicle driver can easily recognize the relation of the vehicle to the obstacle 11 without viewing the greatly distorted part.

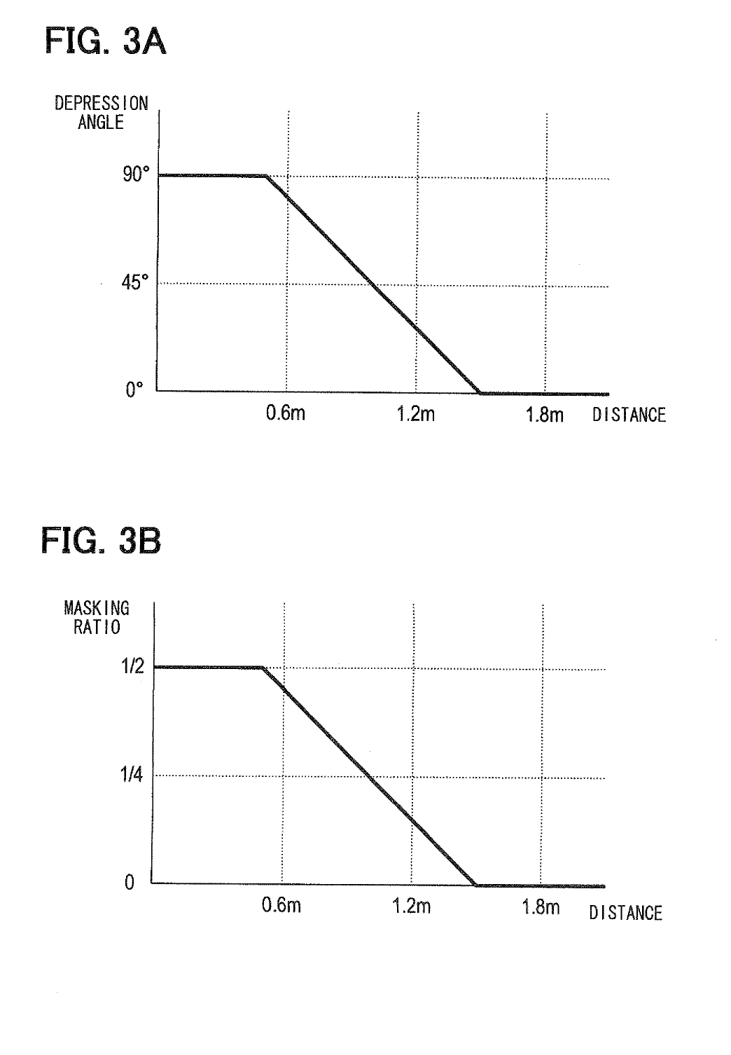

In this embodiment, the depression angle of the bird's-eye view is varied with the distance between the vehicle and the obstacle as shown in FIG. 3A, and the ratio of masking section to the whole display area of the display 7 (masking ratio) is also varied with the distance between the vehicle and the obstacle as shown in FIG. 3B. As a result, as shown in FIGS. 2A to 2D, as the distance from the vehicle to the obstacle becomes shorter, the depression angle is increased and the masking section 13 is increased.

The depression angle may be changed in steps (for instance, 0, 30, 60 and 90 degrees) between 0 degree and 90 degrees in accordance with the distance to the object in place of the linear change shown in FIG. 3A. The depression angle may be changed over a different range (for instance, between 0 degree and 80 degrees, or between 10 degrees and 90 degrees) in place of the range of change (between 0 degree and 90 degrees) shown in FIG. 3A.

The masking ratio may be changed in steps (for instance, 0, ¼, ½) in accordance with the distance to the object in place of the linear change shown in FIG. 3B. The masking ratio may be changed over a different range (for instance, between 0 and ⅔, or between 0 and ¼) in place of the range of change (between 0 and ½) shown in FIG. 3B.

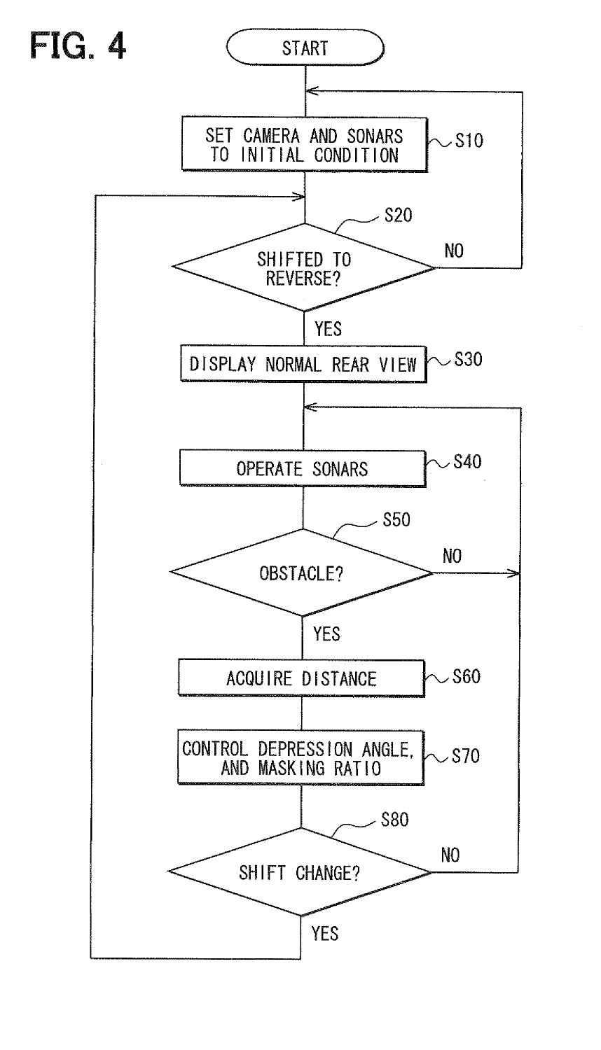

For the above operation of the embodiment, the ECU 1 is programmed to execute the processing shown in FIG. 4 in cooperation with the signal processing unit 5B. This is only a part of entire processing the ECU 1 executes.

The ECU 1 executes this processing while a vehicle engine is in operation.

After this processing is started, the ECU 1 sets the sonars 3 and the intelligent camera device 5 to respective initial conditions at S10, so that the ultrasonic sonars 3 and the intelligent camera device 5 do not operate. The ECU 1 then checks at S20 whether a vehicle transmission gear is shifted to the R-position for moving the vehicle rearward.

If it is not shifted to R-position (520: NO), S10 and S20 are repeated. As a result, the ultrasonic sonars 3 and the intelligent camera device 5 continue to be inoperative.

If the gear is shifted to R-position (S20: YES), the ECU 1 starts a normal rear view image display at S30. In this normal rear view image display, a rear view image is provided by the display 7. This rear view image corresponds to a bird's-eye view image generated with the least depression angle as shown in FIG. 2A. As a result, the vehicle driver is enabled to recognize even an obstacle existing far behind the vehicle more easily than when the depression angle is increased.

The ECU 1 then controls at S40 the ultrasonic sonars 3 to transmit and receive ultrasonic waves, so that information of detection of an obstacle is acquired from the ultrasonic sonars 3. The ECU 1 checks at S50 whether an obstacle is detected. If no obstacle is detected (S50: NO), the processing returns to S40 to repeat S40 and S50.

If any obstacle is detected (S50: YES), the ECU 1 acquires at S60 a distance between the vehicle and the detected obstacle, which is measured by the ultrasonic sonar 3 which detected the obstacle. The ECU 1 further controls at S70 a depression angle and a masking ratio.

Specifically, at S70, the ECU 1 supplies the intelligent camera device 5 with the measured distance to the detected object acquired at S60, so that the intelligent camera device 5 may cut out a part of the bird's-eye view image by a cut-out angle determined in correspondence to the measured distance. The intelligent camera device 5 responsively generates the bird's-eye view image in a depression angle determined in correspondence to the measured distance by the ECU 1.

Receiving the bird's-eye view image from the intelligent camera 5, the ECU 1 synthesizes with the bird's-eye view a masking section for masking the upper part of the view image and warning information for providing warning in the masking section. The warning information includes a picture symbol indicating the level of approach of the vehicle to the obstacle and a character message. The size of the masking section and the warning message are varied in accordance with the depression angle or the distance by referring to the predetermined control characteristics shown in FIGS. 3A and 3B. The ECU 1 causes the display 7 to provide the bird's-eye view image, which includes the masking section at the top part, and the picture symbol and the character message in the displayed view image.

The ECU 1 finally checks at S80 whether the shift position has been changed from the R-position. If it has not been changed (S80: NO), the processing returns to S40 to repeat S40 to S80. If it has been changed (S80: YES), the processing returns to S40.

As a result, if the shift position is still at the R-position (S20: YES), the ECU 1 executes S30 to S80. If the shift position is not at the R-position (S20: NO), the processing returns to 510 and stops the operations of the ultrasonic sonars 3 and the intelligent camera device 5.

According to the embodiment, even if the bird's-eye view image generated by the intelligent camera device 5 partly includes a greatly distorted section, such a distorted section can be masked by the masking section 13 on the display 7. As a result, the displayed view image can be modified not to puzzle the vehicle driver by the distortion of the view image.

Since the depression angle of the bird's-eye view generated by the intelligent camera device 5 and the ratio of the masking section 13 are varied in correspondence to the measured distance between the vehicle and the obstacle. Therefore, the depression angle and the masking ratio are varied in correspondence to each other.

Specifically, the area of the bird's-eye view image masked by the masking section 13 is increased as the depression angle of the bird's-eye view image increases. Therefore, the bird's-eye view image can be formed to enable easy recognition of an obstacle existing at a far-away position by setting a small depression angle, and easy recognition of an obstacle existing nearby by setting a large depression angle.

If the distortion of the view image is increased with the increase in the depression angle, such an increased distorted area can be masked by increasing the masking area or masking ratio of the masking section 13. Thus the vehicle driver will be released from being oppressed by unusualness of the displayed view image.

Further, the depression angle of the bird's-eye view image which is generated by the intelligent camera device 5 can be automatically varied in accordance with the distance to the obstacle 11 measured by the ultrasonic sonar 3. Therefore, the depression angle need not be varied manually. As a result, even if the part of the bird's-eye view image distorted noticeably changes in the display 7 in response to changes of the depression angle, which is varied in correspondence to the distance to the obstacle, the area of masking can be changed in correspondence to such a change of the distorted part.

The warning information including picture symbols and/or characters are displayed in the masking section 13 in an overlapping manner and the contents or types of such warning information are varied in correspondence to the distance to the obstacle 13. Therefore, the sense of unusualness of the distortion appearing in the bird's-eye view image can be minimized. Further, useful information can be provided to the vehicle driver by making the best use of the masking section 13.

The color of the masking section 13 is varied in correspondence to the distance to the obstacle 11. Therefore, the vehicle driver can easily sense the degree of approach and danger instinctively by the change in colors of the masking section 13 without reading the character message or thinking of meaning of the displayed picture symbol.

The above embodiment may be modified in many other ways.

The warning message displayed in the masking section 13 in the overlapping manner need not be provided in the masking section 13. The warning message may be different from the characters and picture symbols shown and described above. For instance, the distance to the obstacle and/or the vehicle speed may be indicated numerically.

It is possible to indicate which one of a plurality of ultrasonic sensors 3 has detected the obstacle. The character message may be displayed in different modes, which include frame-in/frame-out of characters by roll/scroll, change of colors of characters, change of size of characters, change of fonts, etc.

The masking section 13 may be maintained in the same color. A particular one of ultrasonic sonars 3, which has actually detected the obstacle, may be indicated in different color from the other ultrasonic sonars.

The depression angle of the bird's-eye view image may be varied manually. In this instance, the masking ratio may be varied in correspondence to the manually-varied depression angle thus masking the distorted area in the bird's-eye view image as desired by the vehicle driver.

The depression angle of the bird's-eye view image may be varied manually and automatically in correspondence to the distance to the obstacle. If the depression angle is variable both manually and automatically, the depression angle may be varied automatically when the obstacle is detected and varied manually as the vehicle driver desires when no obstacle is detected. Even in this case, the masking ratio may be varied in accordance with the depression angle.

What is claimed is:

1. A vehicle periphery monitoring system comprising:
imaging means mounted in a vehicle for taking an original view image of a vehicle periphery, which is in a predetermined area from the vehicle;
image processing means connected to the imaging means for converting at least a part of the original view image and generating an imaginary bird's-eye view image corresponding to the original view image; and
display means mounted in the vehicle for displaying the bird's-eye view image in a vehicle compartment,
wherein the image processing means is configured to synthesize a masking section, which masks a part of the bird's-eye view image not to be viewed and variable with respect to an area of masking.

2. The vehicle periphery monitoring system according to claim 1,
wherein the image processing means is configured to variably set a depression angle of the bird's-eye view image in generating the bird's-eye view, and to increase the area of the masking section as the depression angle increases.

3. The vehicle periphery monitoring system according to claim 2, further comprising:
detection means mounted in the vehicle for detecting an obstacle present in the predetermined area from the vehicle,
wherein the image processing means is configured to vary the depression angle of the bird's-eye view image in correspondence to a distance of the vehicle to the obstacle.

4. The vehicle periphery monitoring system according to claim 3,
wherein the image processing means is configured to increase the depression angle of the bird's-eye view image as the distance to the obstacle decreases.

5. The vehicle periphery monitoring system according to claim 3,
wherein the image processing means is configured to display information by characters and picture symbols in the masking section and vary contents of the information in correspondence to the distance to the obstacle.

6. The vehicle periphery monitoring system according to claim 3,
wherein the image processing means is configured to vary color of the masking section in correspondence to the distance to the obstacle.

7. The vehicle periphery monitoring system according to claim 1,
wherein the image processing means is configured to synthesize the masking section to appear at an upper part of the bird's-eye view image.

8. The vehicle periphery monitoring system according to claim 1,
wherein the image processing means is configured to increase a height of the masking section as a distance of the vehicle to an obstacle is decreased.
